(19) United States
(12) Patent Application Publication
(10) Pub. No.: US 2006/0256976 A1
(43) Pub. Date: Nov. 16, 2006

(54) Spatial array monitoring system

(76) Inventor: William Neal House, Greenwood, IN (US)

Correspondence Address: INDIANAPOLIS OFFICE 27879;BRINKS HOFER GILSON & LIONE, ONE INDIANA SQUARE, SUITE 1600, INDIANAPOLIS, IN, 46204-2033, US

(21) Appl. No.: 11/273,876

(22) Filed: Nov. 15, 2005

Related U.S. Application Data
(60) Provisional application No. 60/679,880, filed on May 11, 2005.

(51) Int. Cl. H04R 3/00

(52) U.S. Cl. 381/92

(57) ABSTRACT

A compact portable spatial array sound reproduction system employs a plurality of identical speakers coupled to a mechanical assembly that situates the speakers at a known, fixed distance from each other as well as a central listening point. The speakers can be coupled to a multi-channel amplifier that can be controlled in various known ways to reproduce a desired acoustic experience. The mechanical assembly is designed to be easily assembled and disassembled to permit transport of the system from location to location resulting in the reproduction of the identical acoustic experiences at different locations spaced in time. The system can be employed to standardize the acoustic characteristics of different venues so that uniform aural experiences can be shared simultaneously or sequentially by people at different locations.

### CROSS-REFERENCE TO RELATED APPLICATION

The present application is related to and claims all available benefit to U.S. Provisional Application Ser. No. 60/679,880 filed May 11, 2005.

### BACKGROUND

1. Technical Field

The present disclosure relates to multi-channel sound systems and to apparatus for producing a sound field that can be substantially independent from the acoustical effects of the playback room or environment. Such systems are well suited for producing repeatable and consistent sound fields for auralizing the characteristics of any selected venue at a second venue. As used herein, the term “auralizing” is intended to mean the process or method of rendering audible, by physical or mathematical modeling, the sound field of a source in a space, in such a way as to simulate the binaural listening experience at a given position in a modeled or another space.

2. Related Art

A widely accepted professional standard for speaker placement for multi-channel sound reproduction is the ITU-R BS.775-1. The standard identifies a few well-known points including the positioning of the reference listening point at the center of an imaginary circle having a radius between 2 m and 4 m (min. and max. radius defined in the ITU-R BS.1116-1 recommendation). According to the standard, a center speaker should be placed at a zero-angle reference position directly ahead of the listening point. There should be 60° between the front left and right speakers, with the center speaker in the middle. Both rear speakers should be placed within 100° to 120° from the zero-angle reference position, also known as the center line. If more than two rear speakers are used, they should be symmetrically placed between 60° and 150° from the center line. The acoustical axis of the front speakers—as defined by the speakers' manufacturer—should be approximately at the listener's ear height. The height of the rear speakers may be less critical and an inclination of up to 15° can generally be accepted. The standard also recommends that each of the five speakers be positioned more than 1.1 m from any wall located behind the speaker. Any variations in deployment of the speakers may affect the aural perception of the sound produced by the set of speakers.

Commercial surround sound systems are often installed at wide variance to this standard. Often the speakers selected for the various positions vary widely in sound reproduction characteristics. Small, even insignificant, variations in the sounds produced by such surround sound systems may be undetectable by the ordinary listener, but are very evident to the trained ear of a sound engineer. Special listening rooms have been constructed to permit the evaluation of various audio components or program materials by sound engineers. It has been observed, however, that various listening rooms have differing characteristics that affect the resulting sound field and different evaluations of sound components can result merely from the movement of the same component from listening room to listening room. It has also been observed that listening rooms of the same general design can have differing characteristics, due to construction and material variations, that affect the resulting sound field. This lack of listening room uniformity presents problems for audio system engineers in component design and standards compliance. The acoustic differences in the various listening rooms may be attributable to the differences in wall placement and covering as well as many other factors.

In many regards, it would be desirable to be able to make professional listening rooms acoustically identical so that component designs could be more objectively assessed. This is particularly true of circumstances where evaluations of components or program materials may take place in different cities or countries. Such acoustically identical listening rooms could then be used as a consistent reference system to create “anchors” for various levels of audio system quality. It would also be desirable to be able to modify the acoustic character of such listening rooms in a purposeful way using digital signal processing to achieve, if desired, reproduction of the spatial characteristics of known venues such as various cathedrals, night clubs, stadiums, concert halls, automobiles, home theatres, studios, etc. It would also be desirable to be able to consistently reproduce multiple directional sound cues around listeners located in different rooms, automobiles, buildings, or even countries, so that a common acoustic experience could be assured at different locations, either simultaneously or spaced in time. It would also be desirable to provide systems capable of consistently reproducing multiple directional sound that faithfully reproduced the “sound room” quality in rather restricted environments such as home theaters, game rooms, home offices, and the like.

### SUMMARY

Accordingly, a compact spatial array sound reproduction system employs a plurality of identical speakers coupled to a mechanical assembly that situates the speakers at known, fixed distance from each other as well as a central listening point. The speakers can be coupled to a standard surround sound reproduction system. The speakers can also be coupled to a multi-channel signal processing amplifier that can be controlled in various known ways to reproduce a desired acoustic experience. The mechanical assembly can be permanently installed in a single location. The assembly can also be designed to be easily assembled and disassembled to permit transport of the system from location to location resulting in the reproduction of the identical acoustic experiences at different locations spaced in time. The mechanical assembly can be designed to have minimal interference or reflective character so that its acoustic impact on the sound field developed by the speakers may be insignificant.

The assembly can employ a plurality of spacing elements coupled together at prescribed locations. The assembly can be provided with a plurality of hinges that allow the spacing elements to be folded one on another into a compact package for easy transport from location to location. Other coupling means can be employed such as plug, bayonet, or even screw connections between the spacing elements. The spacing elements can be supported by vertical standards that couple to the spacing elements. The spacing elements and the vertical standards can be adjustable in length. The vertical standards can be used to support the spacing elements with respect to any underlying surface such as a floor or desk top. The vertical standards can also be used to suspend the spacing elements from a ceiling or other overhead structure. The spacing elements can include all the wiring necessary to couple the speakers to the amplifier outputs as well as jacks to facilitate the connection between the wiring and the speakers. The jacks can be located so as to position speakers at the standard ITU angles around a central listening position, but can also be included at other locations. The radial separation of the speakers from the central listening position can be smaller than the ITU standard to facilitate the use of near-field monitoring techniques.

Each speaker can be designed to couple directly to the spacing elements with mating connectors, including banana jacks, in the vicinity of one of the hinges. The mechanical coupling between the speaker and the spacing elements can be sufficient to immobilize the hinge. Additional hinge immobilization elements can be employed. The speakers preferably have an enclosure volume of no less than about 0.5 liter. The speakers can also have a sound reproduction range of at least 80 Hz to 20 kHz, and a power handling capability of at least 15 Watts. A suitable speaker that can be used in the present system is an Odyssey Warrior manufactured by Harman International. Other speakers or speaker assemblies, of comparable performance characteristics can also be employed. Low frequency responsive speakers can also be added to the system, if desired. The speakers can be coupled to the outputs of a multi-channel signal processing amplifier such as a Harman Kardon model AVR 630. Other DSP amplifiers can be used that have at least comparable sound reproduction and control characteristics. The speaker assembles can also be beneficially used with other amplifier systems to achieve satisfactory, if not optimal, sound reproduction capabilities to enhance the listening experience of the ordinary listener, particularly in home theatre or game station situations. In another embodiment, the spacing elements can also be used to house and enclose the speaker drivers, The spacing elements can be constructed from plastic tubing that fits together to form an array of various dimensions with speaker locations as needed to suit various specific requirements including non-standard azimuths and elevations.

Using such a portable spatial array sound reproduction system, a sound engineer can minimize acoustic reflections and resonances to produce a sound field that may be substantially independent from the acoustical effects of the playback room or other environment in which the system may be installed. Therefore, the acoustical characteristics recorded into a signal source can better be demonstrated without the added effects caused by the playback environment and boundaries. Also, the system can be used as a means to consistently reproduce an acoustic sound field for purposes of listener training and testing, subjective referencing for evaluations, mixing/mastering, and other activities. Such a portable system can be used by a sound engineer to mimic the acoustic characteristics of any venue in which it may be installed. Preferably, the direct acoustic energy should be more than 10 dB higher in level than the early reflected acoustic energy that occurs within 10 ms and more than 20 dB higher in level than the reflected acoustic energy that occurs after 15 ms. This can be determined by measuring the impulse response of each speaker with a microphone located at the listener's position.

Other systems, methods, features and advantages will be, or become, apparent to one with skill in the art upon examination of the following figures and detailed description. It is intended that all such additional systems, methods, features and advantages be included within this description, be within the scope of, and be protected by, the following claims.

### BRIEF DESCRIPTION OF THE DRAWINGS

The present system can be better understood with reference to the following drawings and description. The components in the figures are not necessarily to scale, emphasis instead being placed upon illustrating the principles of the system. Moreover, in the figures, like referenced numerals designate corresponding parts throughout the different views.

FIG. 1 is a block diagram of a multi-channel surround sound amplifier that can be used in a spatial array sound reproduction system.

FIG. 2 is a schematic plan view of a representative spatial array sound reproduction system.

FIG. 3 is a schematic plan view of another spatial array sound reproduction system.

FIG. 4 is a plan view of a single tubular element that can be used to construct the spatial arrays shown in FIGS. 2 and 3.

FIG. 5 is a plan view of a single tubular end element that can be used to construct the spatial array shown in FIGS. 2 and 3.

FIG. 6 is an elevation view of the set of tubular elements such as are shown in FIGS. 4 and 5 that can be used to construct the spatial arrays shown in FIGS. 2 and 3, the tubular elements being folded together for ease of transport between venues.

FIG. 7 is an elevation view of a portion of the set of tubular elements shown in FIG. 6, the elements having been unfolded to form a planar array for use in the spatial array sound reproduction systems of FIG. 2 or 3.

FIG. 8 is an elevation view of a portion of a set of tubular elements immediately prior to connection to a supporting standard.

FIG. 9 is a schematic view of the junction between the tubular element and standard of FIG. 8.

FIG. 10 is an exploded perspective view of an alternate junction between a tubular element of the array and another type of vertical standard.

FIG. 11 is a detail plan view of a hinged junction between two of the tubular elements forming a planar array.

FIG. 12 is a schematic illustration of a connection between the tubular elements and a speaker.

FIG. 13 is a perspective view of a representative spatial array sound reproduction system installed on a desk.

FIG. 14 is a perspective view of a representative spatial array sound reproduction system installed as a suspended array.

FIG. 15 is a perspective view of another representative spatial array sound reproduction system installed on a desk suitable for use in connection with a gaming computer.

### DETAILED DESCRIPTION

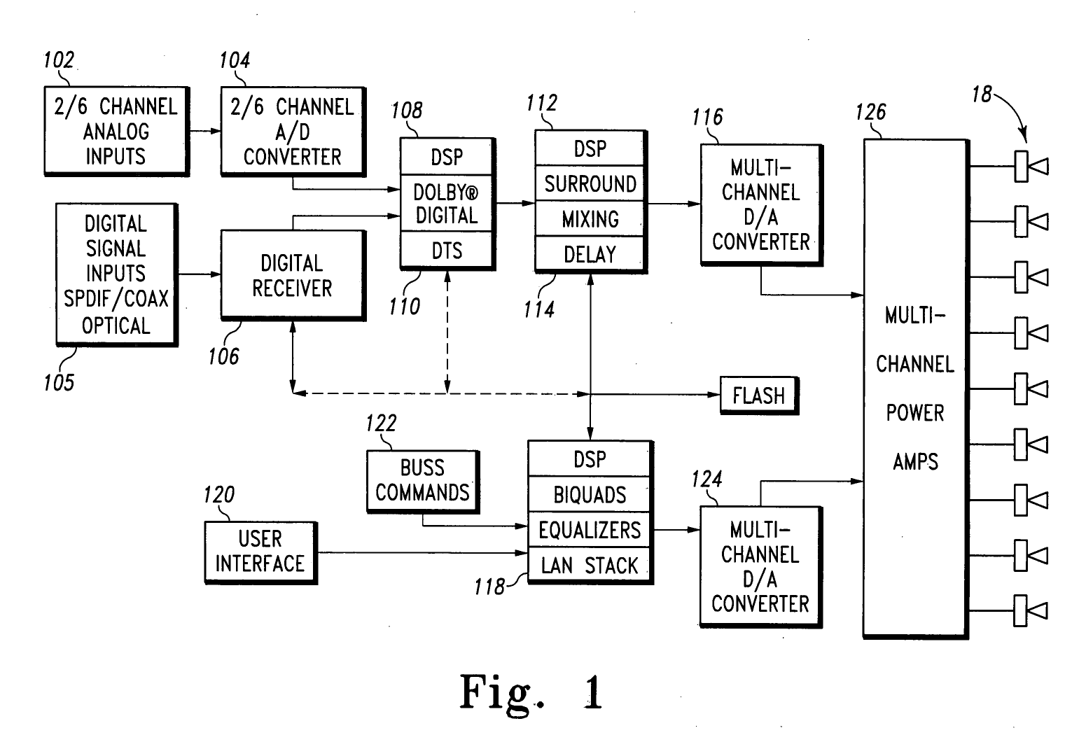

FIG. 1 is a block diagram of a multi-channel surround sound source 100 that can include an analog input stage 102. The analog input stage 102 can include any number of input channels, but typically includes at least two stereo channels (left and right), suitable for accepting an analog signal from a radio or television tuner, a CD, MP3, tape player, or other similar device. The analog input stage 102 can also include an analog to digital converter 104 for converting the signals in each input channel to a digital format to permit digital signal processing methods to be used on the input signals. The sound source 100 can also include a digital input receiver 106 that can be designed to accept digital signals (via SPDIF, AES/EBU) directly from various sources 105 such as a CD or DVD player, cable, satellite, game box, computer, or other similar device with discrete digital signals. Signals output from either or both of the A/D converter 104 and receiver 106 can be fed into a digital signal processing decoder 108 that can include any number of basic conventional commercial decoders 110 such as Dolby® Digital (AC-3), DTS (389r2) as well as others. The output of the signal processing decoder 108 can be directed to a digital signal processing control section 112. The control section 112 can include specific preset processing functional aids 114 to provide for dynamic equalization, delays, mixing, and feedbacks leading to a multilevel surround output that can be fed to a first multi-channel digital to analog converter 116. The control section 112 can also connected to a further control section 118 that includes user interface controls 120 and set buss commands 122 for developing a second multilevel surround output that can be fed to a second multi-channel digital to analog converter 124. A multi-channel power amplifier 126 can amplify the analog outputs of the converters 116 and 124 to achieve a suitable signal for driving a set of speakers 18.

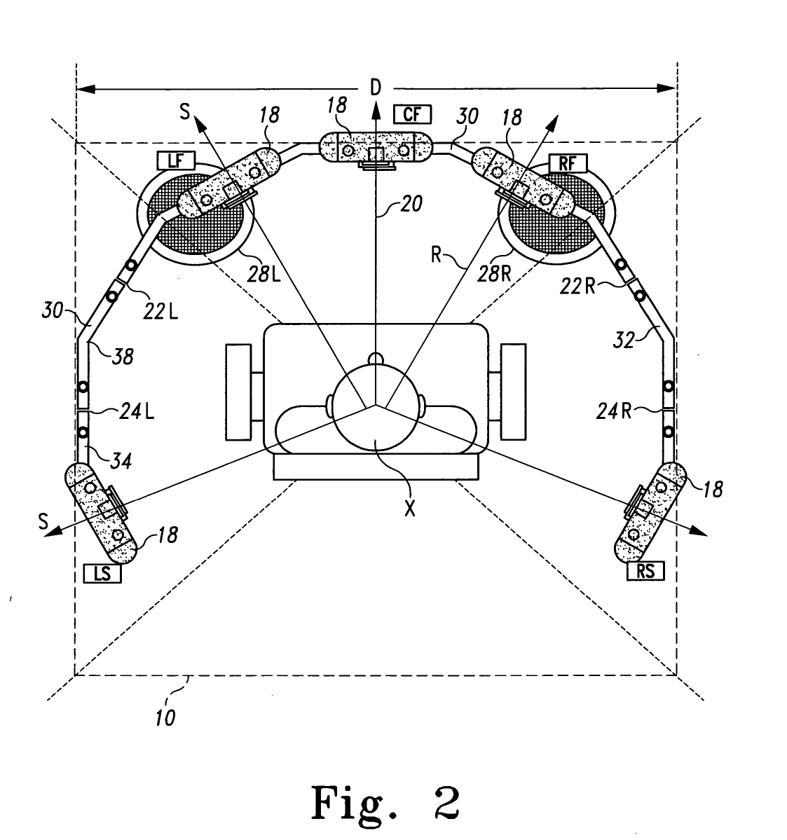

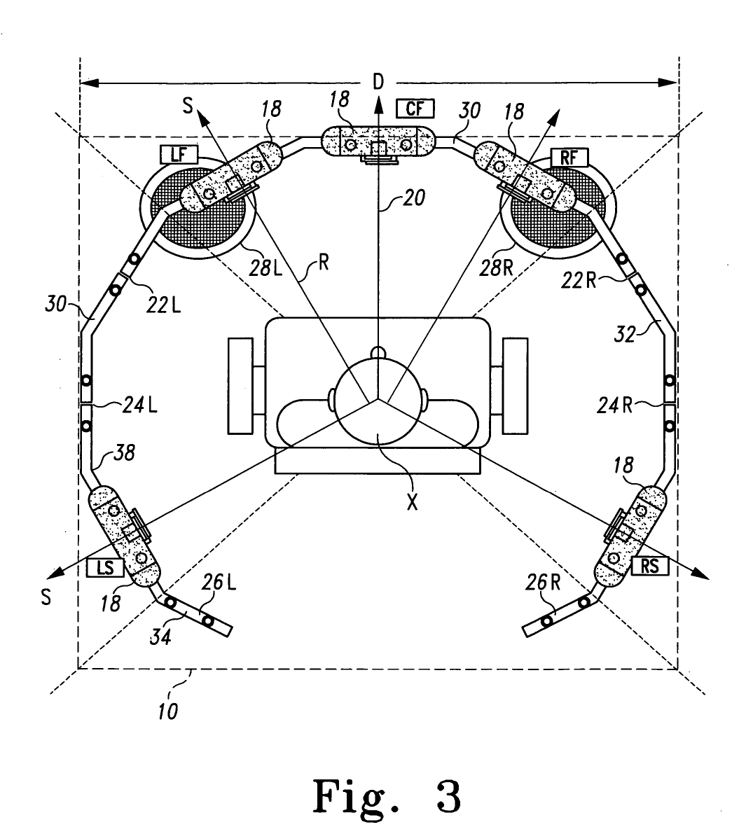

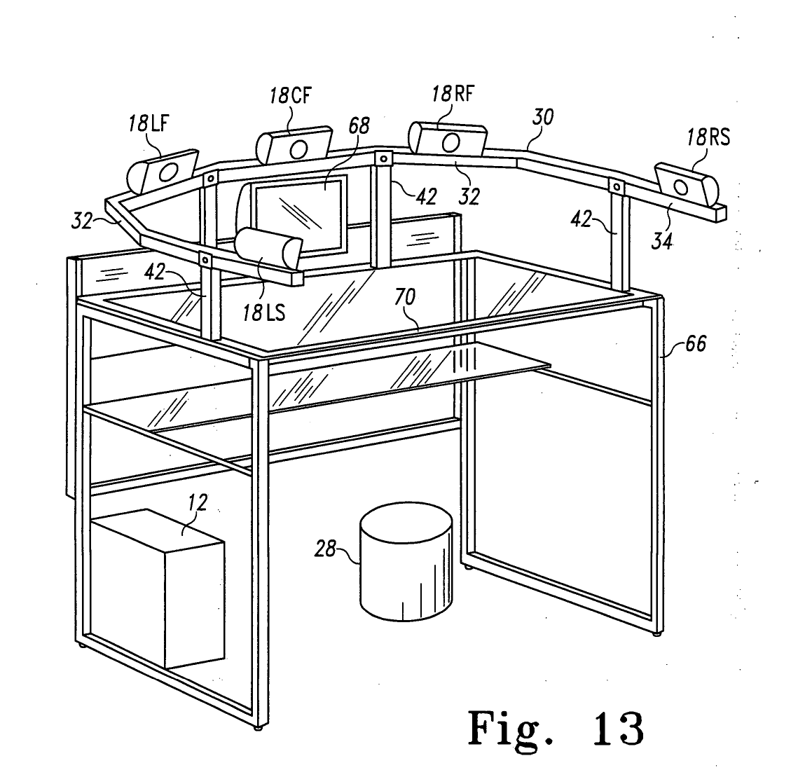

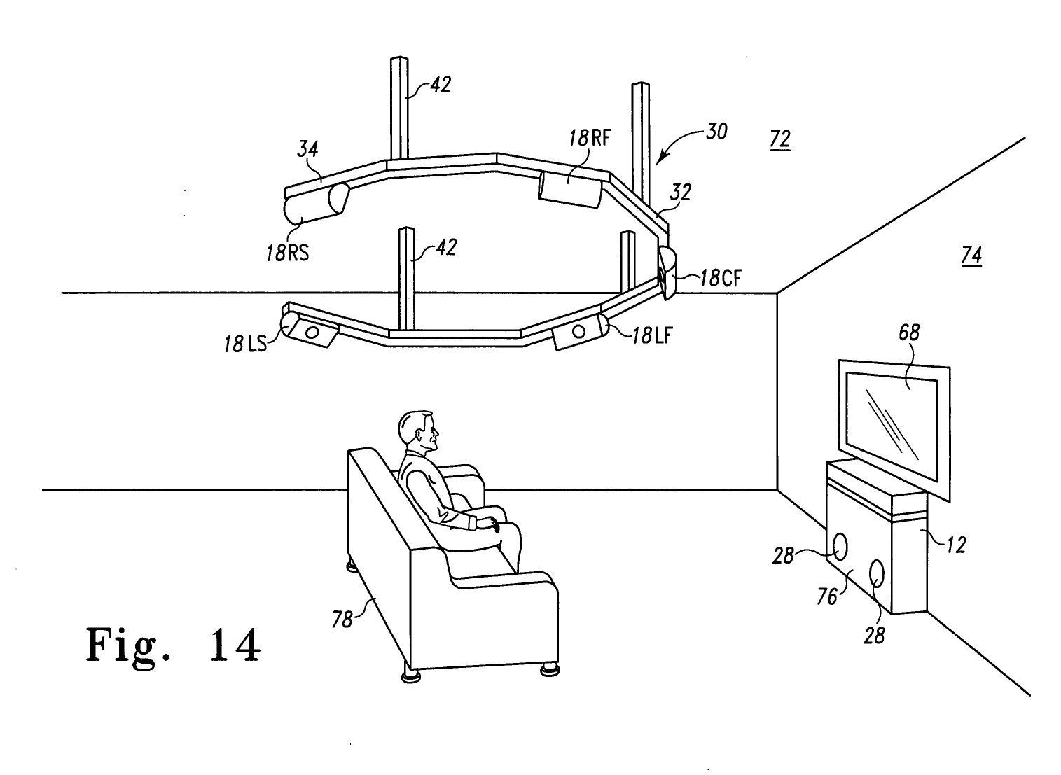

FIGS. 2 and 3 show schematic plan views of spatial array sound reproduction systems 10. Each system 10 includes at least one sound source, which can be a pre-amplified signal that may be output from a radio, television, record turn table, CD player, tape player, I-pod, computer, or other similar device, but preferably the sound source 100 described previously. The sound source generally has suitable controls, such as the user interface controls 120, to permit a sound engineer or other individual situated at position X shown in FIGS. 2 and 3 to control each output of the power amplifier 126. Each of the outputs can be coupled to one of the speakers 18. For example, a center channel output can be connected to speaker 18CF. Front side outputs can be connected to speakers 18LF and 18RF, respectively. Side outputs can be connected to speakers 18LS and 18RS, respectively. Base outputs can be connected to one or more subwoofer speakers, such as speakers 28L and 28R. The spatial array of the system 10 situates the speakers 18 at fixed distances from each other. In both FIGS. 2 and 3, speaker 18CF is situated directly in front of the listener situated at position X, and the line between speaker 18CF and position X can be considered as the zero-angle reference position, and also defines the center line 20. When used in connection with a visual output device such as a computer screen, as shown in FIG. 13, or a television screen as shown in FIG. 14, the speaker 18CF can be positioned in line with, or directly above, the center of the visual output device. Speakers 18LF and 18RF are shown in both FIGS. 2 and 3 to be situated at 30° left and 30° right, respectively, of the center line 20, which may be angularly in accordance with the speaker placement standards for multi-channel sound reproduction specified in the ITU-R BS.775-1. The left and right angular displacement of the speaker 18LF and 18RF can vary between about 25° and 35°, but the angular displacement is desirably consistent from system to system where exact audio reproduction is desired.

In FIG. 2, the speakers 18LS and 18RS are positioned at 111° left and 111° right, respectively, of the center line 20. In FIG. 3, the speakers 18LS and 18RS are positioned at 120° left and 120° right, respectively, of the center line 20. The systems of both FIGS. 2 and 3 include some additional intermediate locations 22L, 22R, 24L, and 24R where other speakers could be added to the system, if desired. FIG. 3 also includes the additional end locations 26L and 26R where still further speakers could be added to the system 10. Alternatively the speakers 18LS and 18RS can be moved to the end locations 26L and 26R, respectively. In general the left and right angular displacement of speakers 18LS and 18RS can vary between about 105° and 140°, but the angular displacement is desirably consistent from system to system where exact audio reproduction is desired.

All of the speakers 18 can be located at a distance R from the position X of the listener, where R is generally between about 0.5 m and 1.5 m, which is considerably closer than the range given in the ITU-R BS.1116-1 recommendation. The distance R to all speakers 18 of a given system can be identical. The outside diameter D of the system 10 can be between about 1 m and 3 m. In the system in FIG. 13, the outside diameter D was constructed to be about 1.2 m so that the radius R was about 0.6 m, thus allowing the listener situated at position X to employ near-field monitoring techniques. Further, the speakers 18 should be positioned away from any adjacent wall by a distance S that is greater than R, so that reflection contributions to the sound being monitored at position X may be minimized. Optional sub-woofers 28L and 28R can also be added to the system if desired, and can be located at positions other than that illustrated in FIGS. 2 and 3. The speakers 18 can be identical to each other, while the subwoofer speakers 28 can be of a different design from speakers 18.

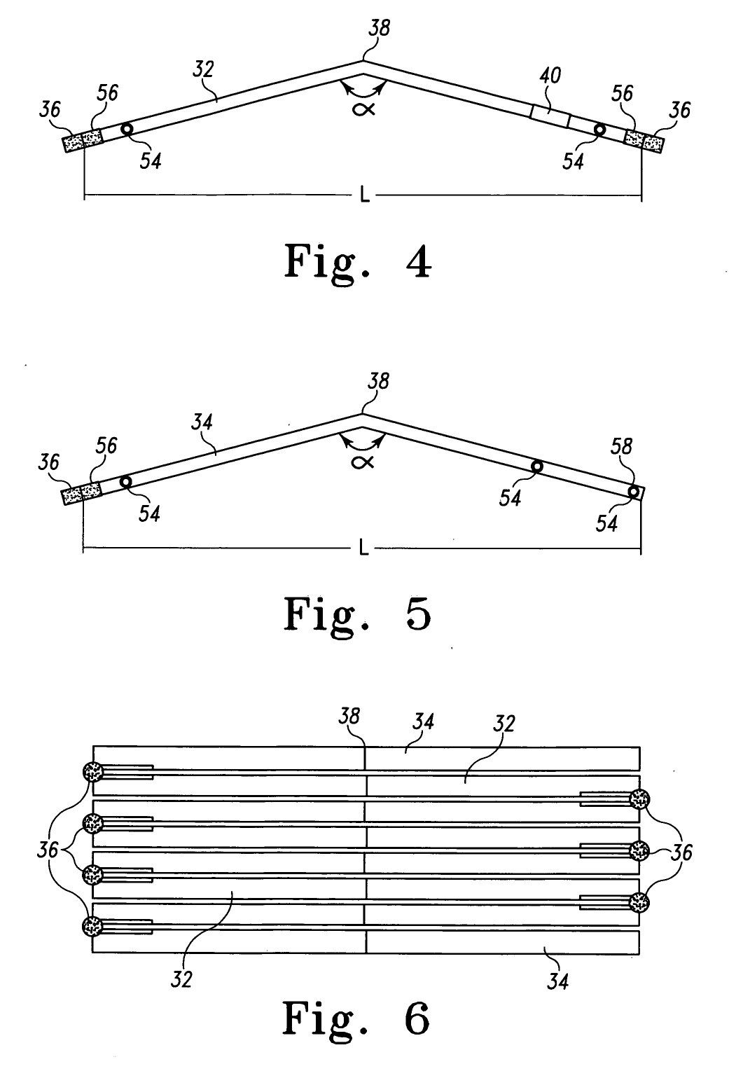

The positions of the speakers 18 relative to the listener, and relative to each other, can be dictated by a mechanical coupling 30. The mechanical coupling 30 can be designed to have minimal interference or reflective character so that the acoustic impact on the sound field developed by the speakers 18 may be insignificant. The mechanical coupling 30 can include a plurality of intermediate spacing elements 32 as well as end spacing elements 34 as shown in FIGS. 4 and 5, respectively. The spacing elements 32 and 34 forming the mechanical coupling 30 can be formed of hollow rigid members such as metal or plastic tubing, which can have any desirable cross-sectional shape. Adjacent spacing elements 32 and 34 can be joined to each other by end structures 36 including releasable portions enabling the system 10 to be easily assembled and disassembled for transport from one location to another location. The end structures 36 can include a hinge so that the mechanical coupling 30 can be folded into a stack as shown in FIG. 5. The spacing elements 32 and 34 desirably have a uniform length L, which will be determined at least in part by the overall dimension D selected for the system 10. The length L adopted for the systems illustrated in FIGS. 2, 3 and 13 can be about 0.6 m. The length L adopted for the system illustrated in FIG. 14 will generally be greater than 0.6 m to permit more than one person to occupy a position in the immediate vicinity of the central position X. The spacing elements 32 and 34 can include a medial bend 38, as shown in FIGS. 4 and 5, which in the illustrated system defines an included angle α of 150°. This medial bend 38 could be replaced by suitable end structures 36 that provided a suitable angular displacement for the spacing elements 32 and 34.

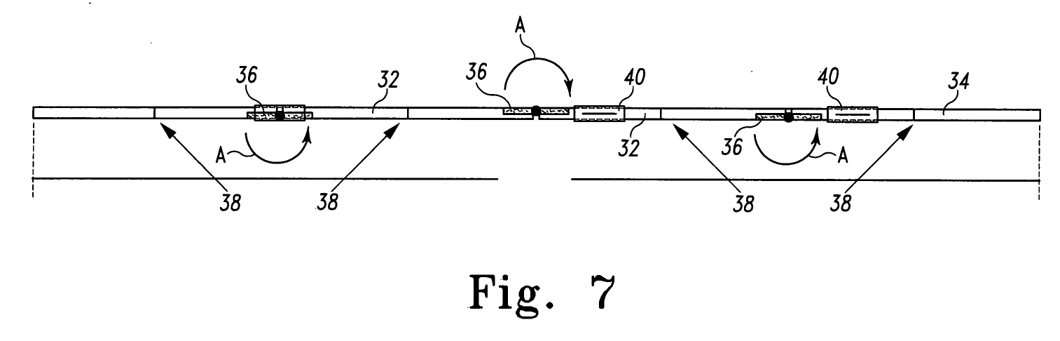

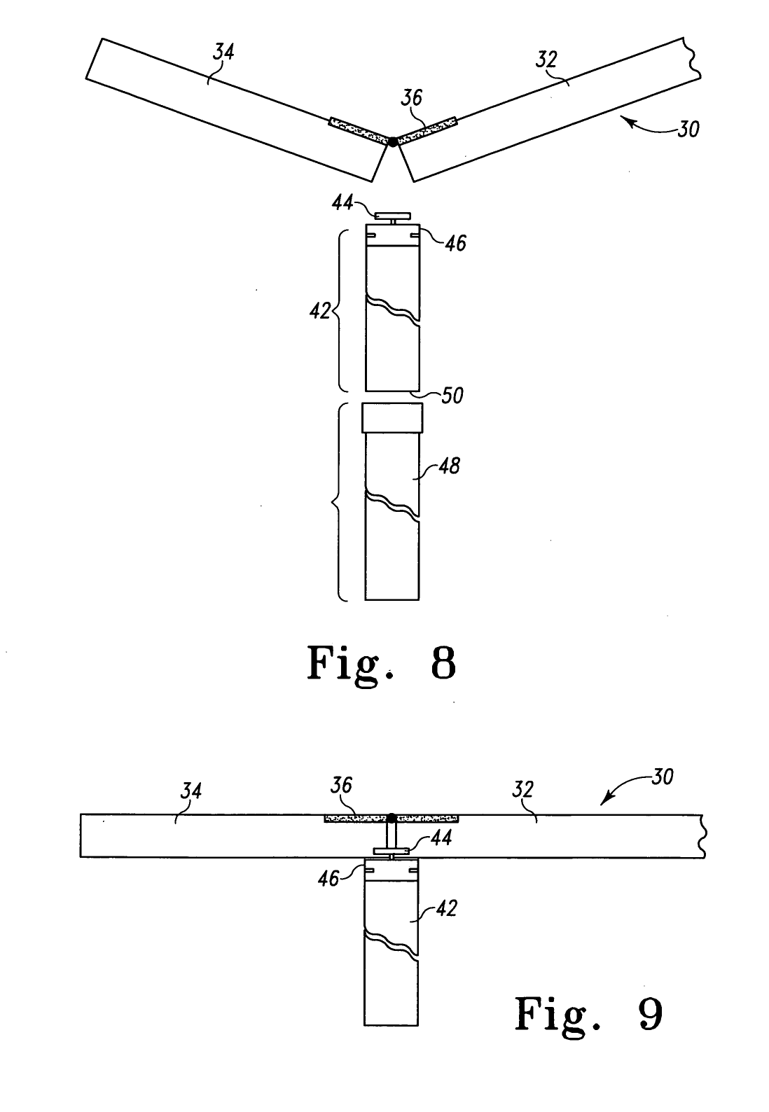

The mechanical coupling 30 that includes hinges at the end structures 36 can be easily deployed by unfolding the stack shown in FIG. 6 in the manner shown by the arrows A in FIG. 7. C-shaped locking channel members 40 can be used to secure the spacing elements 32 and 34 in a coplanar relation to each other at a generally horizontal attitude. A plurality of standards 42 can be provided to support the mechanical coupling 30. As generally indicated in FIGS. 8 and 9, each standard 42 can include a plate member 44 that can be fixed in spaced relation to the end 46 of the standard 42. The spacing between the plate member 44 and end 46 can be sufficient to receive the tubing wall defining the spacing elements 32 and/or 34 opposite a hinge 36. Additional extension members 48 can be added to the ends 50 of the standards 42 opposite end 46 to permit the mechanical coupling to be suitably position vertically in generally planar alignment with the head of the listener located at position X. The vertical displacement of the speakers 18 supported by the mechanical coupling 30 may be no more than about ±15°, and the vertical angular displacement is desirably consistent from system to system where exact audio reproduction is desired.

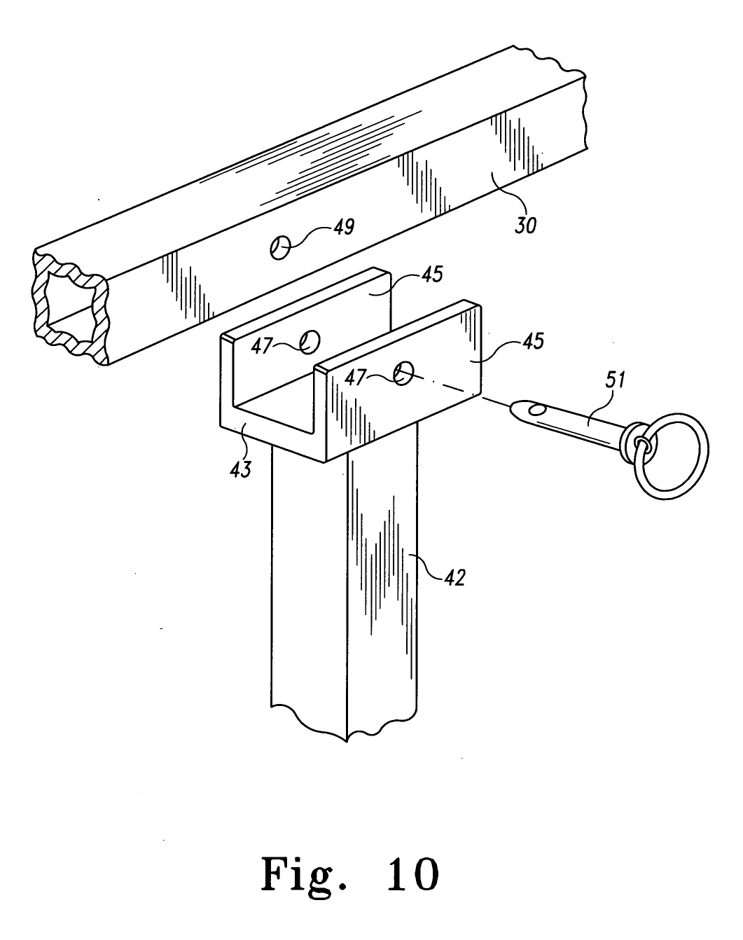

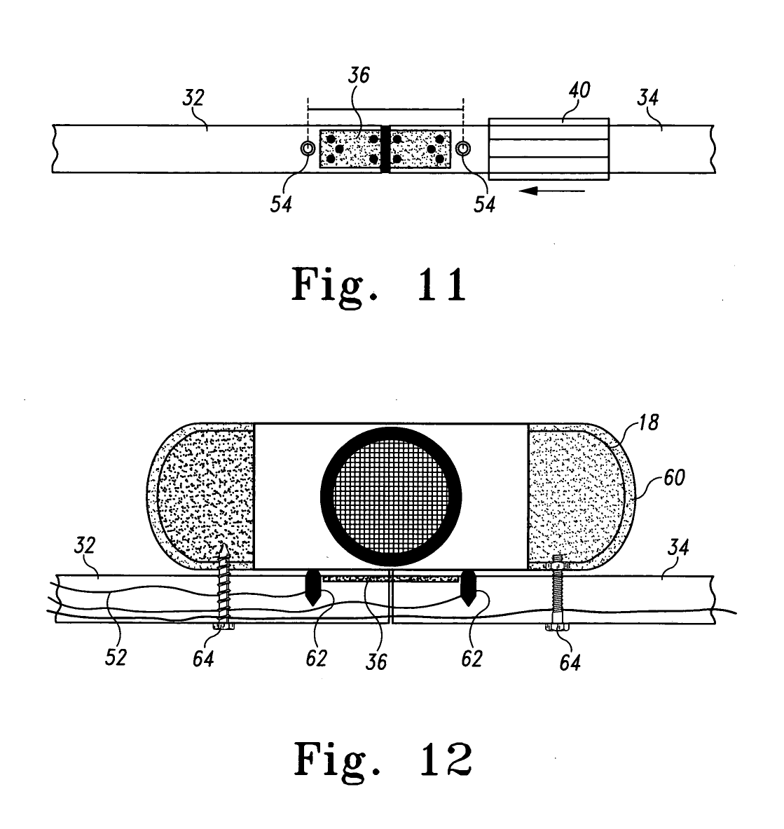

Alternatively, each standard 42 can include a U-shaped channel member 43 as shown in FIG. 10. The U-shaped channel member 43 can be fixed to the upper end of each standard 42 and have two upstanding arms 45 separated from each other by a dimension designed to receive one of the spacing elements 32 or 34 of the mechanical coupling 30. A hole 47 can be provided in each of the upstanding arms 45. Additional holes 49 can be provided at designated points along the spacing elements 32 and 34. A clevis pin, bolt, screw or other fastener 51 can pass though the holes 47 and 49 to couple the upstanding arms 45 to the spacing element 32 or 34 that can be received in the U-shaped channel member 43.

Each of the spacing elements 32 and 34 can contain wiring 52 suitable to connect the amplifier outputs 16 to the speakers 18 through jacks 54 as shown in FIGS. 11 and 12. The jacks 54 can be arranged in pairs so that each speaker 18 can be connected to the contained wiring 52 within the spacing elements 32 and 34 by engagement of two jacks 54. In the case of the intermediate spacing elements 32, one jack 54 can be situated adjacent to each end 56. In the case of the end spacing elements 34, a single jack 54 can be provided adjacent the end 56 having a hinge or other end structure connection to an adjacent intermediate spacing element 32. At the terminal end 58 of the end spacing elements 34, a pair of jacks 54 can be provided as shown in FIG. 5.

A representative speaker 18, shown in FIG. 12, has an enclosure 60 having two protruding prongs 62 that can be engaged in the jacks 54 on opposite sides of an end structure 36 joining two adjacent spacing elements 32 and 34. The speaker enclosure 60, which preferably has a contained volume of between about 0.5 and 1.5 liters, can be secured to the spacing elements by fasteners 64 in the nature of screws or bolts. Where the speakers 18 are employed at the junction of two spacing elements, the use of locking channel members 40 can be omitted since the speaker enclosure 60 when secured by fasteners 64 will ensure that the contiguous spacing elements will be retained in a fixed orientation with respect to each other. The speakers 18 can be any of a wide variety of speakers, however all the speakers 18 secured to the spacing elements of a given mechanical structure 30 should be as consistent in performance as possible. For example, the speaker enclosures 60 can include a multi-transducer grouping, and the amplifier 12 can include suitable controls for adjusting the output of each transducer within the multi-transducer grouping. The speakers 18 are desirably consistent from system to system where exact audio reproduction is desired. The speakers 18 desirably have a substantially flat sound reproduction range from 80 Hz to 20 kHz, and a power handling capability of at least about 15 Watts. By using the same speaker design at all locations, the amplitude and phase characteristics of each speaker's sound filed is the same. This provides a more coherent sound field which improves the spatial sound reproduction aspects of the sound field therefore improving the transparency and naturalness of the reproduced sound.

One possible spatial array sound reproduction system 10 that could be used by sound engineers, computer gamers, and others is shown in FIG. 13. A mechanical assembly 30 can be provided that can be supported by, and may be coupled to, a desk 66. A television or computer screen 68 can be centrally situated on the desk 66 immediately below speaker 18CF. The mechanical assembly 30 includes spacing elements 32 and 34 that situate the other speakers 18LS, 18LF, 18RF and 18RS at known, fixed distance from each other as well as a central listening point located above a front edge 70 of the desk 66. The speakers 18 can be coupled to a multi-channel amplifier 12 of standard surround sound reproduction system or a multi-channel signal processing amplifier that can be controlled in various known ways to reproduce a desired acoustic experience. Vertical standards 42 can be coupled to the spacing elements 32 and 34, and can be coupled to the desk 66 to support the speakers 18 at a desired height, which can be adjustable to accommodate stature differences among listeners.

The vertical standards closest to the screen 68 can be omitted by supporting the spacing elements 32 on the screen 68. In such an installation, it may be desirable to include at least some magnetic shielding adjacent to the speakers 18 so as to not cause interference with the operation of the screen 68. A single subwoofer speaker 28 is shown to be situated under the desk 66, however, any number of subwoofer speakers can be included in the system. It will be appreciated that the height of the desk 66 can be designed for use with a chair, not shown, or could be design to be used by a listener who may be standing rather than sitting. The desk 66 can be a standard permanent desk design, or a portable desk designed for easy assembly and disassembly, similar to the previously described mechanical assembly 30, so that the entire system 10 shown in FIG. 13 can be transferred from location to location to ensure accurate sound reproduction in a variety of locations thereby auralizing the characteristics of any selected venue at a second venue.

For example, a portable spatial array sound reproduction system 10 such as that shown in FIG. 13 can be positioned at a selected venue of interest and the sound characteristics of the venue matched by suitable modification of the various gain controls of the amplifier system 12. The system 10 can then be moved to any other location and the controls returned to the levels matching the venue of interest with assurance that the sound produced by the system 10 will match the sound produced at the venue of interest. Additionally, the information concerning the various gain control levels can be communicated to others having a similar system 10 to permit the recipient to also reproduce the sound characteristics of the venue of interest. If the second location to which the system 10 is moved also has a resident sound system, it is even conceivable that one could calibrate the resident sound system of the second location to inherently have the sound characteristics of the venue of interest using the portable system 10 as a calibration standard.

FIG. 14 shows another possible spatial array sound reproduction system 10 that could be used for sound evaluation training, or in a home theatre installation, and other similar situations. A mechanical assembly 30 can be provided that can be suspended from a ceiling 72 by the vertical standards 42, which could be adjustable manually or automatically to change in height. Preferably, the vertical position of the speakers 18 should be such that the angular elevation of the speakers is not more than about 20° above the horizontal plane of the listener's ear level. A visual presentation screen 68 can be situated adjacent to a wall 74 of the room above a console 76 that can contain one or more subwoofers 28. A seating location 78, which may be designed to accommodate more than one person, may be provided in line with the visual presentation screen 68 and the speaker 18CF mounted on the assembly 30. The mechanical assembly 30 can include spacing elements 32 and 34 that situate the other speakers 18LS, 18LF, 18RF and 18RS at known, fixed distance from each other as well as the seating location 78. The speakers 18 can be coupled to a multi-channel amplifier 12 of standard surround sound reproduction system or a multi-channel signal processing amplifier that can also be situated in the console 76 and controlled in various known ways to reproduce a desired acoustic experience. The speakers 18 can all be spaced from the walls 74 by a distance that may be greater than the distance between the speakers 18 and the seating location 78 to minimize any reflection, diffraction or other interference with the direct sound field information from the speakers 18. Using the calibration information developed at a venue of interest as described in the previous paragraph, a sound system 10 located in a playback venue as shown in FIG. 14 can be adjusted to reproduce the same sound characteristics. Additionally, the suitable gain control level information necessary to reproduce the sound characteristics of a musical selection recorded at such a venue of interest can be provided as a part of the reproduced recording or broadcast so that a suitable adjustment of the controls of the sound system of the playback venue can occur automatically, thereby facilitating simultaneous reproduction of the sound characteristics of a venue of interest at a number of different locations.

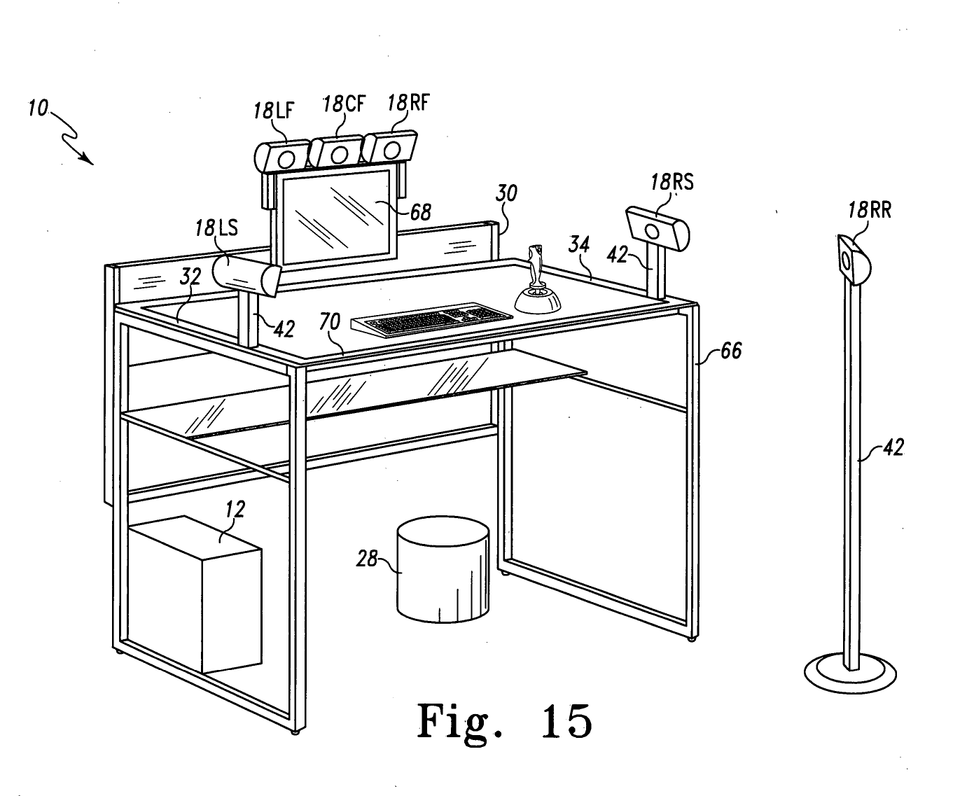

FIG. 15 shows another possible spatial array sound reproduction system 10 that could be used in connection with a gaming computer, or for sound evaluation training, or in other situations. A mechanical assembly 30 can be provided that can be supported by the computer screen 68, and may be coupled to desk 66. The computer screen 68 can be centrally situated on the desk 66 so that the computer screen supports speakers 18CF 18LF and 18RF. In such an installation, it may be desirable to include at least some magnetic shielding adjacent to the speakers 18 so as to not cause interference with the operation of the screen 68. The mechanical assembly 30 can also include spacing elements 32 and 34 forming a part of the desk 66 that situate other speakers 18LS and 18RS at known, fixed distance from each other as well as a central listening point located above a front edge 70 of the desk 66. Additional speakers such as rear speaker 18RR can be positioned at a spaced location behind the listener or game player to further enhance the surround sound experience. The speakers 18 can be coupled to a multi-channel amplifier 12 of standard surround sound reproduction system or a multi-channel signal processing amplifier that can be controlled, by a gaming computer or other computer in various known ways to reproduce a desired acoustic experience. Vertical standards 42 can be coupled to the spacing elements 32 and 34, and can be coupled to the desk 66 to support the speakers 18 at a desired height, which can be adjustable to accommodate stature differences among listeners or game players. A subwoofer speaker 28 can be situated under the desk 66, however any number of subwoofer speakers can be included in the system. It will be appreciated that the height of the desk 66 can be designed for use with a chair, not shown, or could be design to be used by a listener or game player who may be standing rather than sitting.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A spatial array sound reproduction system for auralizing characteristics of any selected venue by using near-field monitoring techniques, the system comprising:
at least one signal source, a multi-channel amplifier coupled to the signal source, the amplifier having a plurality of outputs and controls for controlling each output of the amplifier,
a plurality of speakers coupled to the outputs of the amplifier, and
a mechanical assembly coupling the plurality of speakers together so that the speakers are located at a substantially constant radius R from a selected central point, the mechanical assembly having a small cross-sectional area as compared to the speakers to minimize any impact on a sound field developed by the speakers.

2. The spatial array sound reproduction system of claim 1 where the mechanical assembly comprises a plurality of standards for supporting the speakers at selected distance from an underlying horizontal surface.

3. The spatial array sound reproduction system of claim 2 where the standards include an extensible element for adjusting the distance of the speakers from any underlying horizontal surface.

4. The spatial array sound reproduction system of claim 2 where the mechanical assembly comprises a plurality of spacing elements of fixed length and connecting elements for connecting the spacing elements to the standards.

5. The spatial array sound reproduction system of claim 4 where the spacing elements comprise hollow rigid members containing wiring for coupling the speakers to the amplifier outputs.

6. The spatial array sound reproduction system of claim 5 where the mechanical assembly comprises releasable portions enabling the system to be disassembled for transport from one location to another location.

7. The spatial array sound reproduction system of claim 6 where the releasable portions include hinges permitting at least some of the spacing elements to be folded relative to adjacent spacing elements.

8. The spatial array sound reproduction system of claim 6 where the releasable portions include jacks and plugs for connecting each of the speakers to the wiring contained within the spacing elements of the mechanical assembly.

9. The spatial array sound reproduction system of claim 1 or 8 where all of the speakers that are located at the constant radius R have the same sound reproduction characteristics.

10. The spatial array sound reproduction system of claim 9 where all of the plurality of speakers located at the constant radius R have a sound reproduction range of 80 Hz to 20 kHz.

11. The spatial array sound reproduction system of claim 9 where all of the plurality of speakers have a power handling capability of at least 15 Watts.

12. The spatial array sound reproduction system of claim 9 where all of the plurality of speakers have an enclosure volume of no less than about 0.5 liters

13. The spatial array sound reproduction system of claim 9 further comprising at least one additional speaker having enhanced bass characteristics relative to said plurality of speakers located at the constant radius R.

14. The spatial array sound reproduction system of claim 13 where said at least one additional speaker is located at a distance S from said selected central point where S can have a value other than R.

15. The spatial array sound reproduction system of claim 1 or 8 where each of the plurality of speakers that are located at the constant radius R comprises a multi-transducer grouping.

16. The spatial array sound reproduction system of claim 15 where said controls include controls coupled to the multi-transducer grouping controlling the directivity of any sound emitted by the grouping.

17. The spatial array sound reproduction system of claim 1 or 8 where all of the plurality of speakers are situated within ±15° of a common plane containing the selected central point.

18. The spatial array sound reproduction system of claim 1 or 8 where the radius R is between about 0.5 m and 1.5 m.

19. The spatial array sound reproduction system of claim 18 where the plurality of speakers are fixed angularly at the ITU-R BS.775-1 standard angles.

20. A spatial array sound reproduction system for auralizing characteristics of any selected venue by using near-field monitoring techniques, the system comprising:
at least one signal source, a multi-channel amplifier coupled to the signal source, the amplifier having a plurality of outputs and controls for controlling each output of the amplifier,
a laterally extending tubular assembly including a plurality of jacks and wires extending from the jacks through the tubular assembly interior to the amplifier outputs, and
a plurality of speakers having substantially the same sound reproduction characteristics coupled to the jacks on the tubular assembly, the speakers being supported by the tubular assembly, the jacks being situated on the tubular assembly so that the speakers are located at a substantially constant radius R from a selected central point.

21. The spatial array sound reproduction system of claim 20 where the mechanical assembly comprises a plurality of standards for supporting the plurality of speakers at selected distance from an underlying horizontal surface, the standards including an extensible element for adjusting the distance from any underlying horizontal surface.

22. The spatial array sound reproduction system of claim 21 where the tubular assembly comprises a plurality of spacing elements of fixed length, connecting elements for connecting the spacing elements to the standards, and releasable portions enabling the system to be disassembled for transport from one location to another location.

23. The spatial array sound reproduction system of claim 22 where the releasable portions include hinges permitting at least some of the spacing elements to be folded relative to adjacent spacing elements, where the jacks coupled to one of the speakers are located on opposite sides of one of the hinges, the speakers being coupled to the tubular elements by fasteners situated so that the hinges are prevented from moving by the presence of the speakers.

24. The spatial array sound reproduction system of claim or 20 or 23 further comprising at least one additional speaker spaced from the tubular assembly having enhanced bass characteristics relative to the plurality of speakers coupled to the tubular assembly.

25. The spatial array sound reproduction system of claim 20 or 23 where each of the plurality of speakers that are supported on the tubular assembly comprise a multi-transducer grouping, and said controls include controls coupled to the multi-transducer grouping controlling the directivity of any sound emitted by each grouping.

26. The spatial array sound reproduction system of claim 1 or 8 or 20 or 23 where the plurality of speakers that are located at the constant radius R are spaced from any adjacent boundary or surface that would reflect, diffract or otherwise interfere with the direct sound field information from the speakers by a distance D which is greater than R.

27. The spatial array sound reproduction system of claim 1 or 8 or 20 or 23 where said signal source comprises a gaming computer.

28. The spatial array sound reproduction system of claim 27 wherein the gaming computer includes a television or computer screen, and three of the speakers are attached to and supported by the screen.

29. A method of auralizing the characteristics of any selected venue at a second venue, the method comprising the steps of:
providing a spatial array sound reproduction system having at least one sound source, a multi-channel amplifier coupled to the sound source, the amplifier having a plurality of outputs and controls for controlling each output of the amplifier, and a plurality of speakers coupled to the outputs of the amplifier,
positioning the speakers at a constant radius R from a selected central point in the selected venue, the radius R being between about 0.5 m and 1.5 m, each of the plurality of speakers being spaced from any wall in the selected venue by a distance D which is greater than R, and
reproducing the sound characteristics of the selected venue in the speakers coupled to the outputs of the amplifier using near-field monitoring techniques, and recording the positions of the controls,
moving the spatial array sound reproduction system to a second venue,
positioning the speakers at substantially identical positions relative to a new selected central point in the second venue, and
returning the controls to the recorded positions.

30. The method of claim 29 further comprising the steps of:
adjusting a second sound system at the second venue to reproduce the aural characteristics of the spatial array sound reproduction system, and
removing the spatial array sound reproduction system from the second venue while leaving the second sound system at the second venue calibrated to match the aural characteristics of the selected venue.
